(19) United States
(12) Patent Application Publication
(10) Pub. No.: US 2016/0110782 A1
(43) Pub. Date: Apr. 21, 2016

(54) Systems and Methods for Utilizing Hub and Cloud Based Control and Automation in Customer Shopping Experiences and Communication

(71) Applicant: OORT Europe S.A., Wroclaw (PL)

(72) Inventor: Radoslaw Tadajewski, Wroclaw (PL)

(21) Appl. No.: 14/883,572

(22) Filed: Oct. 14, 2015

Related U.S. Application Data
(60) Provisional application No. 62/064,905, filed on Oct. 16, 2014.

(51) Int. Cl. G06Q 30/06; G06Q 30/02

(52) U.S. Cl. CPC G06Q 30/0601; G06Q 30/0237

(57) ABSTRACT

Systems and methods for utilizing hub and cloud-based control and automation in customer shopping experiences and communication are provided herein. In one embodiment, a system includes a smart hub in two-way communication with each of a plurality of beacon devices over a network, the plurality of beacon devices being arranged in a retail establishment in proximity to a location or a product, the plurality of beacon devices providing visual, auditory, olfactory, or temperature messages that direct a consumer associated with a client device to the location or product, and the client device configured to be a user beacon that allow the smart hub to track and communicate with the user beacon and provide navigation within the retail establishment to the location or the product, the client device providing at least one of visual and auditory output.

### CROSS-REFERENCE TO RELATED APPLICATIONS

This non-provisional application claims the priority benefit of U.S. Patent Application Ser. No. 62/064,905, titled “Systems and Methods for Utilizing Hub and Cloud Based Control and Automation in Customer Shopping Experiences and Communication”, filed on Oct. 16, 2014, which is hereby incorporated by reference herein in its entirety, including all references cited therein.

### FIELD OF THE INVENTION

The present technology is directed to systems and methods for enhancing customer shopping experiences and customer communications through the use of hubs, smart devices, and cloud based systems. In general, the hubs and smart devices are used to communicate with customers to provide customer navigation through a retail establishment, highlight products in the retail establishment, or otherwise tailor the customer experience in the retail establishment.

### SUMMARY OF THE INVENTION

According to some embodiments, the present technology is directed to a system that comprises a product display apparatus, comprising: (a) a product display unit that receives and displays a product or group of products, the product display unit being position at a location in a retail establishment; (b) a plurality of beacon devices that are associated with the product display unit, each of the plurality of beacon devices being proximate the product or at least one of the group of products; and (c) at least one smart hub that communicatively couples with the plurality of beacon devices, the at least one smart hub and the plurality of beacon devices being in two way communication with one another, the smart hub comprising a processor and a memory for storing executable instructions, the processor executing the instructions to: (1) transmit control signals to each of the plurality of beacon devices that cause the plurality of beacon devices to output visual, auditory, olfactory, or temperature messages that directs a consumer to the product or the at least one of the group of products.

According to other embodiments, the present technology is directed to a smart hub retail system, comprising: (a) a smart hub in two-way communication with (b) each of a plurality of beacon devices over a network, the plurality of beacon devices being arranged in a retail establishment in proximity to a location or a product, wherein the plurality of beacon devices is selected from any of a smart light, a smart electrical socket, a smart temperature sensor, a smart air quality sensor, a smart scent dispersal device, or other smart device that has an integrated beacon tag; (c) a client device configured to be a user beacon, the smart hub in two-way communication with the user beacon for tracking and communicating with the user beacon to provide navigation within the retail establishment to the location or the product; and (d) the smart hub controlling the plurality of beacon devices and communicating with the user beacon so as to encourage a customer associated with the client device to purchase a product or service.

According to some embodiments, the present technology is directed to a system comprising: (a) a smart hub in two-way communication with each of a plurality of beacon devices over a network, the plurality of beacon devices being arranged in a retail establishment in proximity to a location or a product, the plurality of beacon devices providing visual, auditory, olfactory, or temperature messages that direct a consumer associated with a client device to the location or product; and (b) the client device configured to be a user beacon, the smart hub in two-way communication with the user beacon using an application stored in memory of the client device, the application being executed by a processor, allowing the smart hub to track and communicate with the user beacon and provide navigation within the retail establishment to the location or the product, the client device providing at least one of visual and auditory output.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a schematic diagram of an example retail establishment where aspects of the present technology are implemented.

FIG. 2 is a schematic diagram of an example smart hub system that can be used in the example retail establishment of FIG. 1.

FIG. 3 is a schematic diagram of another example retail establishment and illustrating the navigation of a consumer using a smart hub system and beacons.

FIG. 4 is a flowchart of an example method executed by a smart hub system.

FIG. 5 is a schematic diagram of a greenhouse where aspects of the present technology are implemented.

FIG. 6 is a schematic diagram of an example machine (e.g., computing system) that is used to implement aspects of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

The present technology relates to the use of beacons and hubs to facilitate customer shopping experiences and customer communications such as the delivery of targeted advertisements.

The present technology provides a system for retailers, industry, institutions and cities that allows their customers to dive into new ocean of experiences. Individuals will be able to navigate in a retail establishment (physical store location) using proximity/micro-fencing, light signals, sounds, smell, and/or combinations thereof.

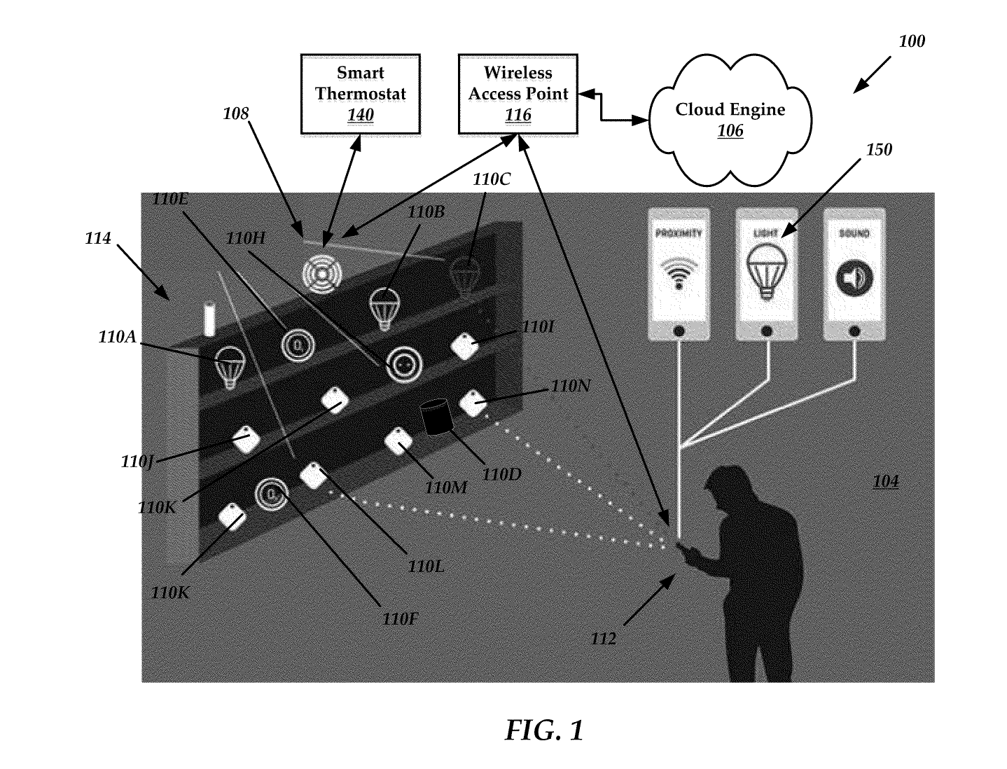

FIG. 1 illustrates an example environment 100 that integrates a portion of a smart hub system 108, which is located in a physical retail establishment 104, with a cloud engine 106. Generally, the smart hub system 108 can include any combination of a smart hub 108, a plurality of beacons 110A-N, and a user beacon 112.

The physical retail establishment 104 comprises a product display unit 114 that can be outfitted with a plurality of different types of beacons and smart hubs that track these beacons and any smart devices or wearable devices.

In one embodiment, a product display unit 114 is a shelving unit in a retail establishment 104. In another embodiment, the product display unit 114 can include a clothing rack, a display sign, a shelving end-cap display, a table, a refrigerator or freezer, or any other physical device where a product can be displayed for sale.

The product display unit 114 is disposed in a particular location within the retail establishment 104. The location of the product display unit 102 can be specified within the smart hub 108. Alternatively, the location of the product display unit 102 can be determined by a wireless access point 116, which links the product display unit 102 to the cloud engine 106.

The wireless access point 116 can communicatively couple with the cloud engine 106 over any public or private network 105. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network.

The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The product display unit 114 is outfitted with the beacons 110A-N. In some embodiments, the beacons 110A-N are smart devices that communicatively couple with the smart hub 108 over a short range wireless connection such as Bluetooth, Near Field Communications, Infrared, Near Infrared, and other similar protocols.

Advantageously, a smart hub 108 can communicate with and control each of the beacons, allowing for two-way communication.

Examples of smart devices that can be used as beacons include, but are not limited to, smart LEDs (light emitting diode), smart electrical sockets, beacon tags (can be attached or integrated into any electrical device), smart air monitors, and smart aroma dispensers—just to name a few.

In one example, a first portion of the plurality of beacons comprises smart lights 110A-C. Each of the smart lights 110A-C can comprise a white light or multicolored LED that is capable of being selectively controlled. A second portion of the plurality of beacons can include a smart speaker 110D.

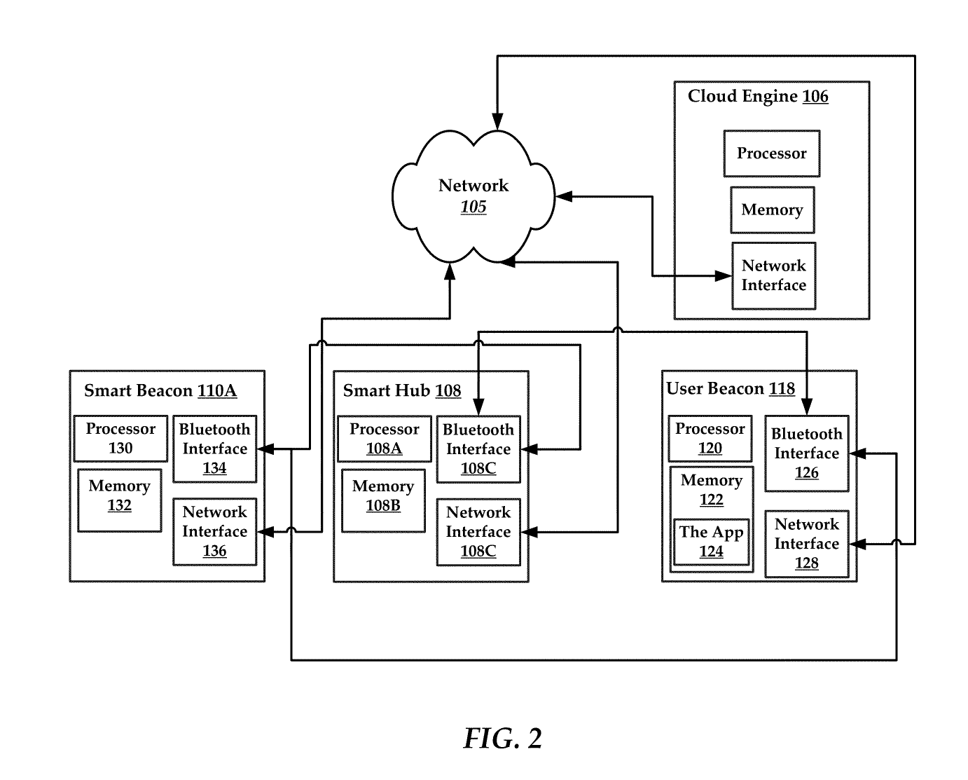

FIG. 2 illustrates an example beacon 110A that comprises a processor 130, a memory 132 for storing instructions, and a Bluetooth interface 134, and an optional network interface 136. The beacon 110A can communicatively couple with the smart hub 108 or the user beacon 118 using the Bluetooth interface 134. The beacon 110A can communicatively couple with the cloud engine 106 using the network interface 136. The other beacons 110B-N can each be configured with the components of beacon 110A. Additionally, each beacon will have sensors, actuators, or other components that are unique to the smart device. For example, a smart light can include a ballast, bulb (semiconductor light), and power source. A smart air quality monitor can comprise an air purity sensor, a carbon monoxide sensor, a temperature sensor, or other types of components.

In one or more embodiments, the environment 100 can comprise a third portion of the plurality of beacons that comprise air quality monitors 110E and 110F. A fourth portion of the plurality of beacons include an aroma (e.g., scent) dispersal device 110G, while a fifth portion can include a smart socket 110H that interfaces with an electronic device. The use of a smart socket 110H allows an otherwise passive electronic device (e.g., an electronic device that is not a “smart” device) to be converted to a smart device. For example, a standard LED light can be converted to a “smart” LED device using a smart socket 110H. The standard LED light is plugged into the smart socket 110H, which is, in turn, coupled to a standard outlet or power source in the retail establishment 104. The smart socket 110H is controllable by the smart hub 108 to at least turn on and off, which causes the standard LED light to illuminate in a solid or blinking pattern, as desired. The smart socket 110H can also monitor power consumption of the standard LED light and/or operational hours. Other similar metrics for the standard LED light can be obtained and stored by the smart hub 108.

In another embodiment, the environment 100 can comprise yet another portion of smart beacons 110I-N, which are smart tags that can be attached to a product. For example, a smart tag can be attached to a product for sale that is placed onto a shelf of the product display unit 114. Any product can be affixed or associated with a smart tag.

The smart hub 108 in some embodiments comprises a processor 108A and memory 108B. The memory 108B stores instructions that when executed by the processor 108A provide various functionalities or methods. For example, the smart hub 108 monitors and stores information for each of the plurality of beacons 110A-N, creating historical information for the system. Also, the smart hub 108 can control the behavior or operations of each of the beacons 110A-N to provide a unique consumer experience. For example, the smart hub 108 can transmit control signals to each of the plurality of beacon devices 110A-N that cause the plurality of beacon devices to output one or a combination of visual, auditory, olfactory, or temperature messages that directs a consumer to the product or the at least one of the group of products. The smart hub 108 can communicate with the plurality of beacons 110A-N and/or user beacon(s) 118 using a Bluetooth interface 108C. The smart hub 108 can communicate with the cloud engine 106 using a network interface 108D, via the network 105.

The smart hub 108 can track the movement of a consumer within the environment 100 by tracking the interactions between a user beacon 118, beacons 110A-N, other smart or wearable devices and the smart hub 108.

The smart hub 108 can be configured to transmit messages directly to the user beacon 118 such as coupons, rewards, a map of the retail environment, as well as other messages. The messages can be displayed on the user beacon 118 in the form of a graphical user interface (GUI). In other instances, messages are output by the user beacon 118 in the form of an audio output. In some embodiments, combinations of message types, both audio and visual, can be provided to the consumer when the user beacon 118 is controlled by the smart hub 108.

Consumers (e.g., end users) within the environment 100 can be associated with the user beacon 118. In one embodiment, the user beacon 118 is a key-fob or a Smartphone or other client device provided with an installed application “App”. A client device/user beacon 118 can comprise any other device that communicates with the beacons 110A-N and/or the smart hub 108. The smart hub 108 can provide the user with visual or audio cues that help the user navigate to a product or location within the environment 100.

The user beacon 118 in FIG. 1 is a Smartphone that at least comprises a processor 120 and a memory 122. An application “App 124” is stored in the memory 122 and is executed by the processor 120 to provide various functionalities. In some embodiments, the App 124 is configured to provide the consumer with various graphical user interfaces (GUI) that allow the smart hub 108 and/or beacons to communicate with the user beacon 118. The smart hub 108 can communicatively couple with the user beacon 118 over a short-range wireless network using a Bluetooth interface 126 or over a network (e.g., WiFi) established by wireless access point 116 using a network interface 128.

The App 124 can include a dedicated mobile app provided to consumers by a retailer, company, city or institution. The App 124 can be connected with loyalty programs. Consumer can be linked with their actions such as purchases or non-purchases. This information can be stored in the cloud engine 106 and incorporated into a user profile for the consumer.

In some embodiments, the smart hub 108 or alternatively the cloud engine 106 is configured to create and update a user profile for a customer. The user profile can include user behaviors, both in physical environments, as well as virtual behaviors such as website usage (e.g., Internet behavior), e-commerce behavior, and so forth. The smart hub 108/cloud engine 106 can use these analytics and metrics to generate advertisements for customers that entice the consumer to enter a retail establishment or provide discounts for products that the smart hub 108 knows are appealing to the user by virtue of knowing their user profile.

The smart hub 108 can selectively control the behavior/operations of one or more of the beacons 110A-N to enhance the consumer experience and/or entice the consumer into purchasing a product.

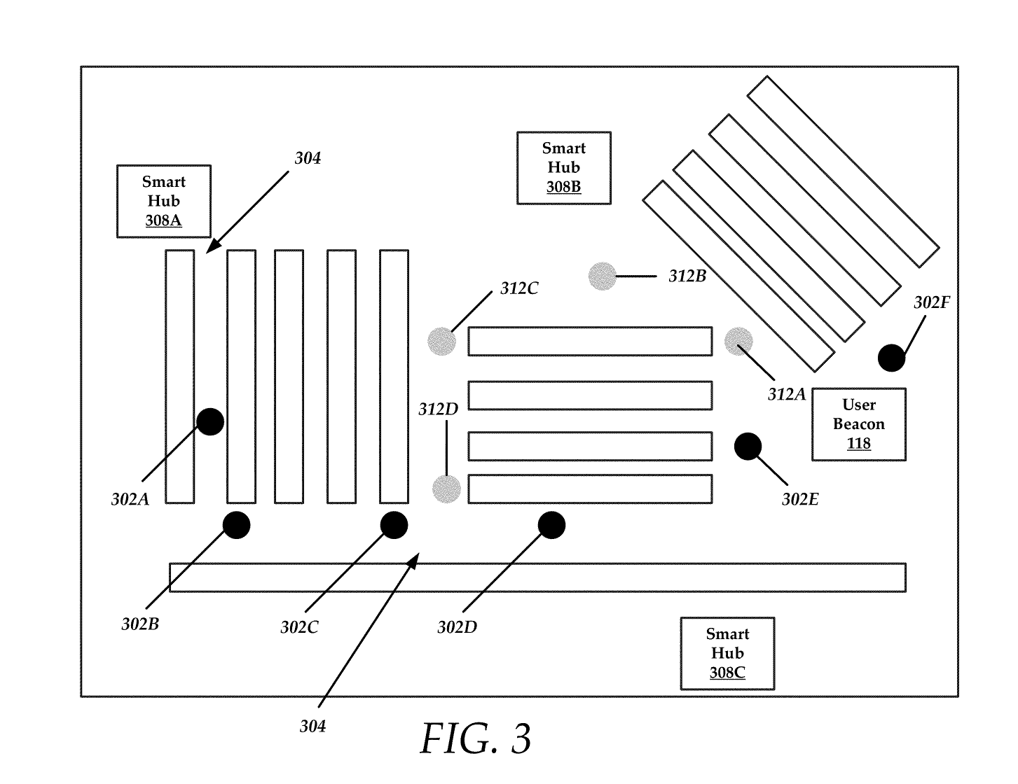

For example, the smart hub 110 can cause one or more smart lights to emit a pattern of light that directs the consumer down a path to a product display unit or a product. FIG. 3 illustrates a plurality of smart lights 302A-F that directs a user beacon 118 down a path 304 to a product display unit 306. The consumer is able to navigate down the path 304 without needless wandering. Various smart hubs 308A-C, positioned through the store, will track the location of the user beacon 118 and selectively illuminate smart lights 302A-F to ensure that the user beacon 118 is traversing the path 304. If the consumer deviates from the path 304, the smart hubs 308A-C can create an alternate path or use other smart lights such as smart lights 312A-D, to redirect the consumer back to the original path 304.

Thus, in some embodiments, the smart hub 108 is configured to selectively control lights that are not associated with the product display unit 114 to emit visual messages that direct the consumer to the product display unit, the lights being disposed in a path between the location of the product display unit and the position of the client device/user beacon 118.

Returning to FIGS. 1 and 2, in addition to guiding or navigating the consumer through an environment to a product, location, or product display unit, the smart hub 108 can direct the user to a specific product or location on a product display unit 114. If the consumer is searching for a specific product on their user beacon 118, the smart hub 108 will locate the searched product in the retail establishment 104. By way of example, the searched product corresponds to a product associated with smart tag 110I, which is on a shelf of the product display unit 114.

The smart hub 108 can transmit signals to the smart light 110C, positioned above the smart tag 110I, causing the smart light 110C to output a pattern of illuminated blinks or a solid illumination.

In some embodiments, the smart hub 108 can cause the user beacon 118 to display a GUI 150 that mimics the illumination of the smart light 110C. This pattern matching between user beacon 118 and smart beacon allow a consumer to differentiate an illumination pattern that is specifically for them, as opposed to another consumer who may be searching for a product at the same time and in the same location.

Thus, the smart hub 108 can service or communicate with multiple user beacons at the same time, providing each consumer with a unique experience (e.g., combination of light, sound, scent, and/or temperature) that is tailored to the user. This unique experience is mimicked for the consumer on their user beacon so that the consumer can differentiate between beacon output that is specifically created for them, as opposed to other consumers.

To help consumers differentiate between products or to identify a particular product from amongst many products, the smart hub 110 can cause a light or speaker to produce output that directs the consumer to the product. The beacon output can be used to aid the consumer in selecting one product over another when the products are very similar to one another, which may lead to the consumer becoming confused and selecting the wrong product. By way of example, when shopping for printer toner or ink, packaging can be misleading. Scores of ink cartridges are sold in confusingly similar packaging. Consumers can often select the wrong cartridge. The smart hub 108 can display an exact location of the correct cartridge by causing a smart LED display or smart light to blink in a pattern that is displayed to the consumer on their user beacon 118.

In one example, the smart hub 108 can cause a smart light(s) to emit a colored pattern such as blue and green alternating flashes. This pattern allows the customer to identify the product by the pattern produced by a light that is proximate the product. The smart hub 108 can also cause the user beacon 118 to display the same visual pattern. This allows the user to compare the display on their phone to the display of the smart light.

In other embodiments, the smart hub 108 can control air quality monitors 110E and 110F and temperature sensors to control the temperature around a display or a product. Likewise, the smart hub 110 can cause an aroma dispersal device 110G to emit a scent around the display or product. Using the smart hub 108, a retailer can use the power of sensory perception to control the behavior of the consumer.

In one example, the smart hub 108 can detect the presence or proximity of the user beacon 118 to the product display unit 114. The user beacon 118 may have been guided to a product on the product display unit 114 or may be near the product display unit 114 of their own volition. The smart hub 108 determines that the consumer has been standing in front of the product display unit 114 for several minutes. To entice the consumer into selecting the product, the smart hub 108 can disperse a scent into the air by transmitting signals to the aroma dispersal device 110G. The aroma dispersal device 110G emits an olfactory output. The olfactory output can be tailored to the preferences of the consumer (as determined from their user profile) or alternatively can be selected from one or more scents or aromas that are known to induce consumer purchases. In one example, the aroma dispersal device 110G can output a lavender aroma as defined by a preference known about the consumer. In another example, the aroma dispersal device 110G can output a scent that is related to the product. If the product is a food, the aroma dispersal device 110G can output a pleasing aroma that includes a scent compound found in the food.

In addition, the smart hub 108 can further entice the consumer by providing a coupon or reward to the consumer by way of the user beacon 118. These olfactory messages can be provided along with visual cues and/or audio cues to further customize the consumers' shopping experience.

In another example, the air quality monitors 110E and 110F can determine a temperature near the product display unit 114 and increase or decrease the temperature to induce consumer behaviors. In one example, the smart hub 108 receives information from the air quality monitors 110E and 110F and determines that the air temperature proximate the product display unit 114 is well below an overall temperature for the retail establishment 104 (calculated from sensor information of other air quality monitors in the retail establishment). Sensing this discrepancy, the smart hub 108 can cause a smart thermostat 140 to adjust the air temperature proximate the product display unit 114 to bring it in line with the overall temperature for the retail establishment 104.

Other individual's behaviors can be driven or influenced by decreasing the temperature in a specific area of the retail establishment 104. For example, the smart hub 108 can reduce employee loitering in certain areas by decreasing temperatures in target locations.

In sum, the smart hub 108 can coordinate a plurality of environment modifying devices (e.g., beacons 110A-N), some of which are configured to provide feedback or input to the five senses of the customer. These types of feedback can encourage the customer to make a purchase or act in a particular or desired manner.

Advantageously, the present technology tracks consumers and builds, in a real time, dedicated actions such as customized dynamic light scenes (e.g., a shelf with a product the user was viewing on a website a few days ago). A smart light can light up when the individual passes by the product in the store. In another example, the present technology can use sounds (some beacons have or are small speakers) getting the consumer's attention. In another example, the present technology can provide rewards or content such as instant discounts, photos, texts, videos, and so forth to a user beacon.

Consumers can be equipped by retailer with the user beacon, such as a key-finder (e.g., key fob) that can be tracked by smart hubs located in shops, warehouses, or other buildings. This tracking information provides knowledge about consumer movements, habits and shopping behaviors.

Combination of smart light, proximity beacons, sound beacons, smart sockets, aroma disposers, smart sensors and smart hubs, cloud engine and mobile applications provide endless possibilities for retailers allowing them to customize their consumer's shopping experiences.

In one embodiment, the smart hub 108 is configured to determine presence of a consumer relative to the product display unit 114. Again, this includes the smart hub 108 determining the location of a user beacon 118, which can include a smart tag or Smartphone. In response, the smart hub 108 will transmit signals to one of the plurality of beacons 110A-N, such as an air quality monitor that control a thermostat to increase or decrease a temperature near the product display unit 114.

In some embodiments, the smart hub 108 is further configured to determine presence of a consumer relative to the product display unit 114 and in response, transmit signals to one or more of the plurality of beacon that is an aroma dispersal device, causing the aroma dispersal device to disperse a scent near the product display unit 114 or a product on the product display unit 114.

Returning back to FIGS. 1 and 2, smart hubs of the present technology can track any Bluetooth devices like wearables (e.g., smart watches or jewelry), smart sensors, or Smartphones. The smart hubs can react to customer needs or behaviors. For example, a smart appliance 128 such as a coffee machine or vending machine can be controlled by the smart hub 108 to provide a consumer with a beverage or refreshment when the smart hub 108 detects that the consumer has been in the retail establishment 104 for a given period of time. The smart hub 108 can transmit to the consumer on their user beacon 118 a message that a free or discounted refreshment is available for them. In another example, an employee can deliver the refreshment to the consumer by obtaining a current location of the user beacon 118.

The rules or circumstances under which the smart hub 108 causes example operations such as these depend upon the desires of the retailer. Thus, the retailer can set rules or logic that are applied by the smart hub 108. For example, the retailer can specify how long a shopper must be in the retail establishment 104 before a free refreshment or other incentive is warranted.

The retailer can set these rules or logic through the cloud engine 106. Also, the cloud engine 106 can create a script for a unique consumer experience that is based on knowledge of the consumer or other parameters described herein. Rather than the smart hub 108 determining details of the unique consumer experience (e.g., permutations of visual, auditory, olfactory, or temperature output), the unique consumer experience is generate by the cloud engine 106 and provided to the smart hub 108. The smart hub 108 then controls various beacons in accordance with the instructions provided by the cloud engine.

For example, the cloud engine 106 can prepare in a real time dedicated unique light pattern to point/highlight particular products, sections or shelves in a unique way. For example, a consumer is looking for a pair of jeans but cannot find them using proximity beacons. The consumer can tap on an icon of a light bulb on their user beacon 118 or tablet and the smart hub 108 will generate a unique light pattern (e.g., bulb on the screen will start blinking on red and green). The consumer need only look around and find a product display unit with a smart light that is blinking the same way the consumer has seen on the screen of the user beacon 118. If the consumer still cannot find the jeans display the consumer can tap an icon of a bell or speaker and proximity beacon with a speaker (hidden somewhere nearby the product) will generate a sound to alert the consumer to the location of the jeans. Again, the consumer is viewing what is displayed on their device by the App that communicates with the smart hub 108.

The smart hub 108 monitors all devices and beacons within its range, giving a retailer real time information about system status, battery level in beacons, and smart sensors. If there is no one in the retail establishment 104 the smart hub 108 can automatically turn off all devices and/or beacons, which saves beacon batteries and reduces maintenance of the same. The smart hub 108, smart devices and/or beacons can be updated any time. That is, Bluetooth devices can be updated (even firmware) over-the-air.

Advantageously, the present technology can incorporate many different kinds of smart devices/beacons such as, but not limited to, smart light bulbs, smart lamps, smart LED strips and other smart light points and systems. In other examples, the present technology can employ smart hubs, proximity beacons with buzzer or other sound source (e.g., speaker), beacon key finders, aroma/aerosol dispenser/streamer or other scent systems, smart thermostats, smart appliances (e.g., smart coffee machine), smart sensors. These devices can be used in combination with smart hubs, cloud engines, and user beacons that implement mobile software applications for communicating with the smart hubs and cloud engines.

Also, the present technology can provide the following advantageous features: (1) easy navigation in buildings (e.g., shop, factory, warehouse, public institution, city); (2) customized marketing/sales communication based on location, context, behaviors, purchase history, habits and other individual patterns; (3) easy shopping experiences and determination of detailed knowledge about products or services; (4) instant customized discounts and information; (5) customized customer experiences, feeling of individual approach and dedicated content/communication; (6) voice and visual guidance for disabled people; (6) simplified navigation through cities, public institutions, museums, tourist attractions; (7) rich media experience (dedicated, based on context and location) such as video clips explaining how product or service works, sound, music connected with product, service or location with detailed knowledge about products and services; (8) direct connection with personnel/sales team/customer support via mobile app; (9) building wish list or cart on mobile app and easy checkout with Smartphone (no need to carry products to the point of sale terminal); (10) customized real time communication client-provider/retailer/during shopping experience/visit in building; (11) real time localized contextual customer experiences removes the mystery of customized dynamic localized shopping process; (12) customer reputation and relationship management; and (13) smart local environment experience—just to name a few.

The present technology also provides distinct advantages for the retailer who implements the present technology in their retail establishment. For example, the present technology provides: (1) deep knowledge about customers—their patterns, tracks, behaviors, habits, and interests; (2) customer location tracking; (3) new communication channels through the use of a dedicated mobile app (push messages, SMS, email), light signals, sounds, and scent, which can all be based on context, location, interests and other factors; (4) connection between online (from Google analytics, Salesforce and similar) and offline activities; (5) metrics about people: number of visits in our buildings (shops, institution, and so forth), ROI (return on investment), actions, purchases, used services, gained loyalty points, value of transactions online and offline, frequency of actions/purchases, locations, available communication channels (email, push message, SMS, call, other), personal data, any graphs and schemes, efficiency of marketing campaigns; (6) in-store analytics (e.g., retailers can obtain consumer information in real time during the shopping experience; (7) increased ROI and conversion rate (e.g., purchases or non-purchases); (8) measureable link between offline and online activities; and (9) solutions for problems of short lifetime of batteries in beacons.

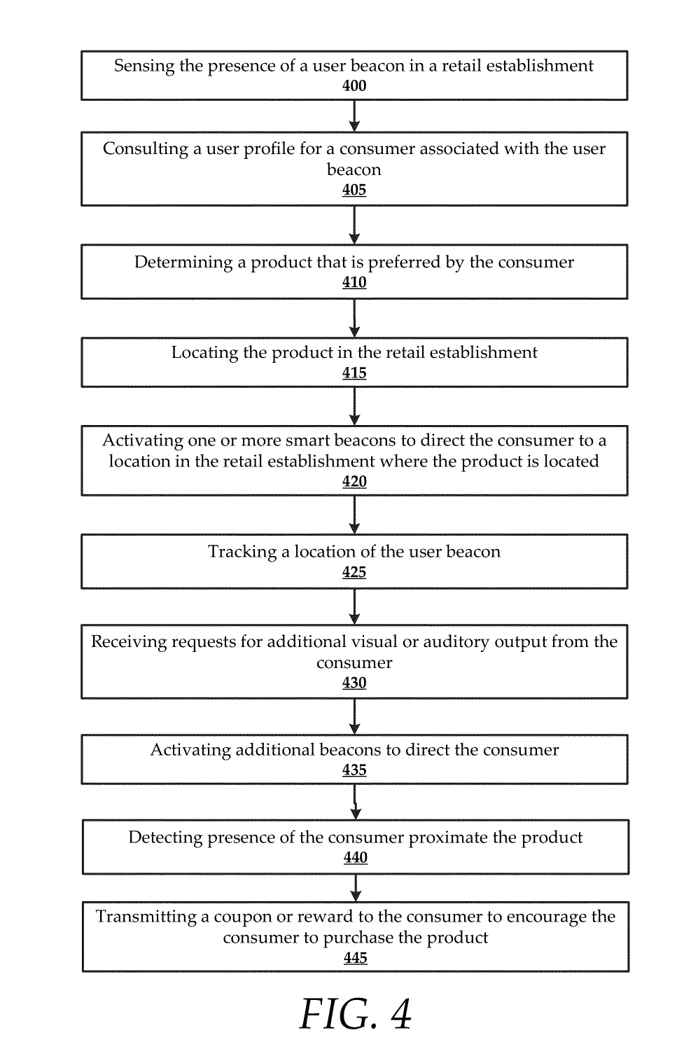

FIG. 4 is a flowchart of an example method executed within a smart hub system of the present technology. The method comprises a smart hub sensing 400 the presence of a user beacon in a retail establishment. The user beacon is linked to a consumer who has a profile stored in a database of a cloud engine. For example, an IMEI, MAC address, or other similar identifier may link the user beacon to the user profile. The method includes the smart hub consulting 405 a user profile for a consumer associated with the user beacon, as well as determining 410 a product that is preferred by the consumer. Again, this can include prior shopping habits and patterns as well as Internet browsing and shopping behaviors for the consumer.

Alternatively the consumer can enter a search query for a product into their user beacon. The method includes the smart hub locating 415 the product in the retail establishment and activating 420 one or more smart beacons to direct the consumer to a location in the retail establishment where the product is located. These steps are conducted in combination (or in conjunction with) the smart hub tracking 425 a location of the user beacon. The smart hub will deduce which beacons should be used to guide the consumer based on knowing the location of both the user beacon and the product, as well as any smart beacons disposed therebetween. Again, it is noteworthy that the product is associated with a smart tag that communicates with the smart hub.

In some embodiments, the method can include the smart hub receiving 430 requests for additional visual or auditory output from the consumer, such as when the consumer cannot locate the product despite smart beacon activation. The method includes the smart hub activating 435 additional beacons to direct the consumer. The method can include the smart hub detecting 440 presence of the consumer proximate the product, as well as optionally transmitting 445 a coupon or reward to the consumer to encourage the consumer to purchase the product. In some embodiments, an optional step of causing beacons to output temperature and/or olfactory messages can be included.

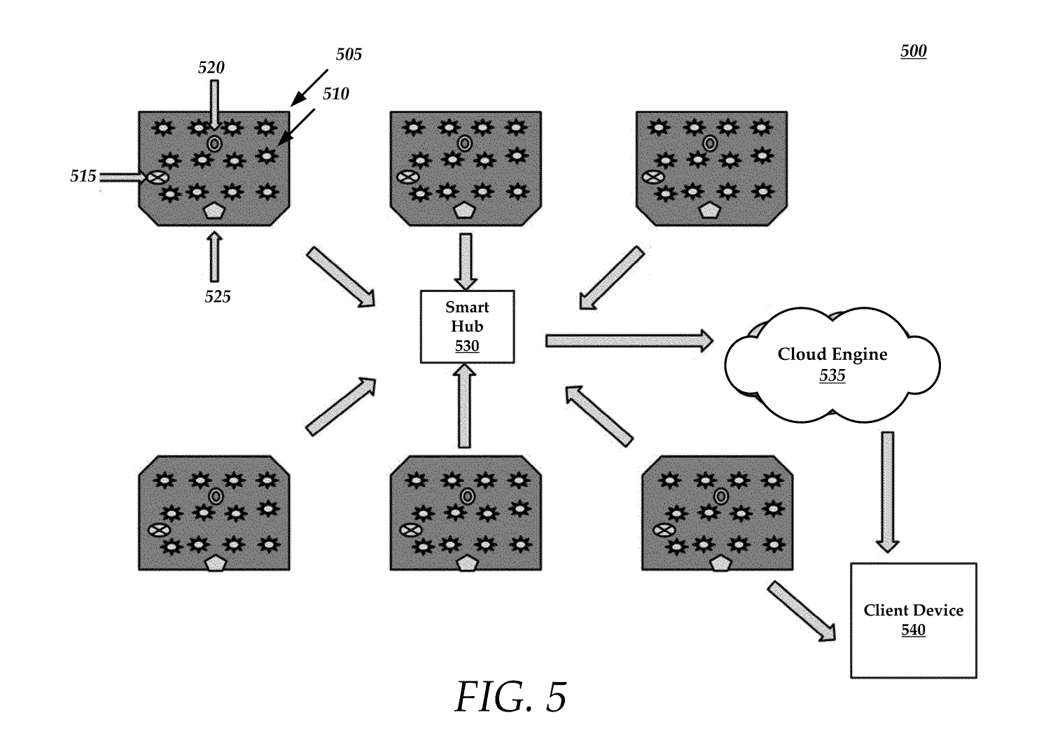

While the above descriptions contemplate the beacon, hub, and cloud technology for use with retail establishments for purposes of selling products, the present technology is not so limited. FIG. 5 includes an additional example implementations where the present technology is utilized. Again, these examples are merely for explaining the present technology. The present technology is not limited to these examples.

Referring now to FIG. 5, a greenhouse 500 is illustrated. The greenhouse 500 comprises various growing beds such as bed 505 that include plants 510. Each bed is provided with, for example, an air quality sensor 515, a humidity and temperature sensor 520, as well as an insolation sensor 525. The insolation sensor 525 measures solar light intensity in the bed 505. The information gathered by the sensors 515, 520, and 525 are transmitted using Bluetooth communications to a smart hub 530. The smart hub 530 can service each beacon (sensor) in the greenhouse 500. In some embodiments, multiple smart hubs can be implemented.

The sensors can be powered using solar power or wind power, if available.

The gathered information can be stored in the cloud engine 535 and displayed on a client device 540 such as an end user computing device or control system. In some embodiments, the sensor information is stored in the cloud engine 535 and is accessed by the client device 540 for further analysis.

In yet another embodiment, the present technology can be used to track students in a school and provide collected information to parents. In this embodiment, a beacon is associated with a student. Smart hubs positioned around the school, for example, at entrances/exits of the school, will collect information about the student such as location and movement through the day. This information is stored in a cloud engine and can be accessed by a parent. In some instances, emails or message can be transmitted to the parent directly. For example, if a smart sensor detects that the student has exited the school during the middle of the day, the parent can be sent an email or SMS message.

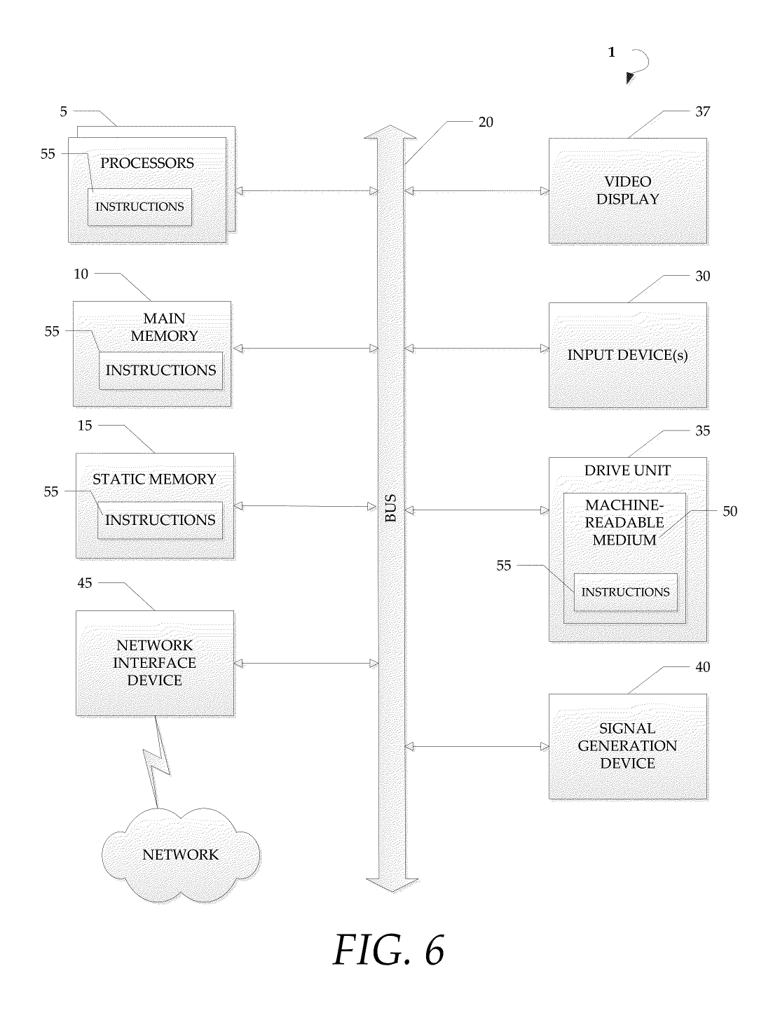

FIG. 6 is a diagrammatic representation of an example machine in the form of a computing system 1, within which a set of instructions for causing the machine to perform any one or more of the methodologies discussed herein may be executed. The computing system 1 (or certain components thereof) can be used in the smart hub 108, smart beacons 110A-N, the user beacon 118, and the cloud engine 106 of FIGS. 1 and 2.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing system 1 includes a processor or multiple processors 5 (e.g., a central processing unit (CPU), a graphics processing unit (GPU), or both), and a main memory 10 and static memory 15, which communicate with each other via a bus 20. The computing system 1 may further include a video display 35 (e.g., a liquid crystal display (LCD)). The computing system 1 may also include an alpha-numeric input device(s) 30 (e.g., a keyboard), a cursor control device (e.g., a mouse), a voice recognition or biometric verification unit (not shown), a drive unit 35 (also referred to as disk drive unit), a signal generation device 40 (e.g., a speaker), and a network interface device 45. The computing system 1 may further include a data encryption module (not shown) to encrypt data.

The disk drive unit 35 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computing system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing systems that are coupled to the Internet service, and that the computing systems may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A product display apparatus, comprising:
a product display unit that receives and displays a product or group of products, the product display unit being position at a location in a retail establishment;
a plurality of beacon devices that are associated with the product display unit, each of the plurality of beacon devices being proximate the product or at least one of the group of products; and
at least one smart hub that communicatively couples with the plurality of beacon devices, the at least one smart hub and the plurality of beacon devices being in two way communication with one another, the smart hub comprising a processor and a memory for storing executable instructions, the processor executing the instructions to:
transmit control signals to each of the plurality of beacon devices that cause the plurality of beacon devices to output visual, auditory, olfactory, or temperature messages that directs a consumer to the product or the at least one of the group of products.

2. The product display apparatus according to claim 1, wherein the processor of the at least one smart hub further executes the instructions to transmit control signals to each of the plurality of beacon devices that cause the plurality of beacon devices to output a combination of visual, auditory, or olfactory messages.

3. The product display apparatus according to claim 1, further comprising a cloud system that transmits to a client device, located in the retail establishment, a product identifier message that comprises a visual pattern that when displayed by the client device is identical to a visual message that is output by one or more of the plurality of beacon devices.

4. The product display apparatus according to claim 3, wherein the cloud system is configured to:
store consumer behavior;
determine a consumer preference for a product on the product display unit from the stored consumer behavior; and
provide to the consumer a coupon for the product.

5. The product display apparatus according to claim 3, wherein the processor of the smart hub is further executed to track a position of the client device in the retail establishment and stores the position in the cloud system.

6. The product display apparatus according to claim 3, wherein the processor of the smart hub is further executed to direct a user of the client device to the product display unit by:
comparing a position of the client device in the retail establishment to the location of the product display unit; and
selectively controlling lights that are not associated with the product display unit to emit visual messages that direct the user to the product display unit, the lights being disposed in a path between the location of the product display unit and the position of the client device.

7. The product display apparatus according to claim 1, wherein the visual pattern includes a representation of a light that is flashing, the flashing of the representation of the light being identical to a visual message that is output by one of the plurality of beacon devices that is a light.

8. The product display apparatus according to claim 1, wherein the plurality of beacon devices comprises any of a light, a speaker, an air quality monitor, a thermostat, and a scent dispersion device.

9. The product display apparatus according to claim 1, wherein the processor of the smart hub is further executed to turn off the plurality of beacon devices when a customer is not present at the location.

10. The product display apparatus according to claim 1, wherein the processor of the smart hub is further executed to:
determine presence of a consumer relative to the product display unit; and
transmit signals to one of the plurality of beacon devices that control a thermostat to increase or decrease a temperature near the product display unit.

11. The product display apparatus according to claim 1, wherein the processor of the smart hub is further executed to:
determine presence of a consumer relative to the product display unit; and
transmit signals to one or more of the plurality of beacon devices that is a scent dispersal device to disperse a scent near the product display unit.

12. A smart hub retail system, comprising:
a smart hub in two-way communication with each of a plurality of beacon devices over a network, the plurality of beacon devices being arranged in a retail establishment in proximity to a location or a product, wherein the plurality of beacon devices is selected from any of a smart light, a smart electrical socket, a smart temperature sensor, a smart air quality sensor, a smart scent dispersal device, or other smart device that has an integrated beacon tag;
a client device configured to be a user beacon, the smart hub in two-way communication with the user beacon for tracking and communicating with the user beacon to provide navigation within the retail establishment to the location or the product; and
the smart hub controlling the plurality of beacon devices and communicating with the user beacon so as to encourage a customer associated with the client device to purchase a product or service.

13. The smart hub retail system according to claim 12, wherein the smart hub further transmits control signals to each of the plurality of beacon devices that cause the plurality of beacon devices to output a combination of visual, auditory, or olfactory messages.

14. The smart hub retail system according to claim 12, further comprising a cloud system that transmits to the client device a product identifier message that comprises a visual pattern that when displayed by the client device is identical to a visual message that is output by one or more of the plurality of beacon devices.

15. The product display apparatus according to claim 1, wherein the visual pattern includes a representation of a light that is flashing, the flashing of the representation of the light being identical to a visual message that is output by one of the plurality of beacon devices that is a light.

16. The smart hub retail system according to claim 14, wherein the cloud system is further configured to:
store consumer behavior that comprises Internet browsing behaviors;
determine a consumer preference for a product on the product display unit from the stored consumer behavior; and
provide to the consumer a coupon for the product.

17. A system, comprising:
a smart hub in two-way communication with each of a plurality of beacon devices over a network, the plurality of beacon devices being arranged in a retail establishment in proximity to a location or a product, the plurality of beacon devices providing visual, auditory, olfactory, or temperature messages that direct a consumer associated with a client device to the location or product; and
the client device configured to be a user beacon, the smart hub in two-way communication with the user beacon using an application stored in memory of the client device, the application being executed by a processor, allowing the smart hub to track and communicate with the user beacon and provide navigation within the retail establishment to the location or the product, the client device providing at least one of visual and auditory output.

18. The system according to claim 17, wherein a first portion of the plurality of beacon devices are lights and a second portion of the plurality of beacon devices are speakers, wherein the first and second portions are located on a product display unit that displays products.

19. The system according to claim 18, wherein a third portion of the plurality of beacon devices are air quality monitors and a fourth portion of the plurality of beacon devices are scent dispersal devices, further wherein the third and fourth portions are located near the product display unit, the air quality monitors and scent dispersal devices cooperating to control a quality, temperature, and scent of the air around the product display unit.

20. The system according to claim 18, wherein each product on the product display unit is associated with a smart tag, the smart hub tracking each product by communicating with a respective smart tag.
